(19) United States
(12) Patent Application Publication
(10) Pub. No.: US 2007/0258192 A1
(43) Pub. Date: Nov. 8, 2007

(54) Engineered structure for charge storage and method of making

(76) Inventors: Joel Schindall, Arlington, MA (US); John Kassakian, Newton, MA (US); Riccardo Signorelli, Cambridge, MA (US)

Correspondence Address: CHOATE, HALL & STEWART LLP, TWO INTERNATIONAL PLACE, BOSTON, MA, 02110, US

(21) Appl. No.: 11/429,565

(22) Filed: May 5, 2006

(51) Int. Cl. H01G 9/042; B05D 5/12

(52) U.S. Cl. 361/503; 427/79

(57) ABSTRACT

Engineered structure for charge storage. An electrolyte is disposed between two electrically conducting plates, each plate serving as a base for an aligned array of electrically conducting nanostructures extending from the surface of each plate into the electrolyte. The nanostructures have diameter and spacing comparable to the dimension of an ion of the electrolyte. An electrically insulating separator is disposed between the two plates. A CVD process (or other processes yielding similar results) is used to make the aligned array of electrically conducting nanostructures.

### BACKGROUND OF THE INVENTION

This invention relates to a rechargeable electrical energy storage device and more particularly to an engineered electrode structure for efficient electrical charge storage.

Energy storage devices based on chemical reactions at the electrodes (batteries) are used in a wide range of electrical and electronic devices. Military examples include missile guidance, GPS location and targeting devices, sonabuoys, intrusion detectors, mobile communications and a wide range of portable electronic products. Commercial and industrial examples include an enormous variety of products from flashlights to electronic products to automotive applications.

While there have been certain improvements to batteries, primarily through surface treatments of electrodes and packaging methods, basic battery design still derives from the fundamental technology discovered by Alessandro Volta (the “Voltaic Pile”) in 1800. All of the products mentioned above would be greatly improved if better batteries were available, that is, batteries having lower internal resistance (higher power and efficiency), longer lifetime (more charge-discharge cycles), and better low temperature performance. In addition, an improved electrical energy storage device would enable the development of new and highly desirable products, such as, for example, a practical electric automobile along with significant regenerative efficiency improvements to conventional vehicles.

A well-known alternative to electrochemical energy storage is to store electrical energy as an electric field in a capacitor. Energy storage in a capacitor involves no chemical reaction leading to more efficient storage. A shortcoming of capacitors, however, has been that constraints on surface area and electrode spacing limit even the best capacitors to an energy density that is four or five orders of magnitude less than can be achieved by an electrochemical battery.

In recent years, a carbon/electrolyte/carbon double layer capacitor (DLC), or ultracapacitor, has been developed and commercialized. By using an activated carbon coating to increase the electrode surface area, combined with an ionic electrolyte to permeate the carbon pores and at the same time reduce the effective electrode spacing to half an ion diameter (about 7 Angstroms), a DLC can achieve an energy storage density that is orders of magnitude higher than a basic capacitor. DLCs are not a typical household product, but they are used in the millions to supply backup power for small electronic devices, and larger capacity units (2500 to 5000 farads) are being actively considered by automobile manufacturers to augment the basic car battery for the purpose of regenerative energy storage. For example, these devices are incorporated into the electric braking system of the Toyota Prius automobile, and into the drive train to provide acceleration power in the developmental Honda fuel cell vehicle.

The DLC was first developed by Standard Oil of Ohio Research Center in the early 1960's, but there was initially no market and limited understanding of the operating principles. During the 1990's, a number of electronic products began to incorporate small (several farads) ultracapacitors as “keep-alive” batteries. In the last few years a number of companies such as Panasonic and Osaki Glass in Japan, NESS in South Korea, Maxwell in the US, and EPCOS in Europe, began to manufacture larger (2500 to 5000 farad) capacitors as energy storage components for utility and automobile applications. These devices typically achieve energy densities on the order of 6 Wh/kg (about 5% of the energy density of a lithium ion battery). They utilize activated carbon to achieve large electrode surface area, and organic electrolyte to achieve maximum voltage ratings on the order of 2.7 V.

Automated assembly techniques have reduced ultracapacitor cost from about $2/farad in 1985 to 10 cents/farad today. Indications are that cost will continue to drop significantly, with a goal of 1 cent/farad. Since the raw materials are inexpensive and the manufacture is straightforward, it appears to be only a matter of time and demand until ultracapacitor cost (for equivalent quantities) will match the cost of an equivalent-volume battery.

However, the best of today's DLCs still provide only a fraction (between 1 and 10 percent) of the energy storage density offered by batteries. They are viewed as battery supplements rather than battery replacements.

An alternate technology for increased electrode surface area, termed the nanogate (M. Okamura and H. Nakamura, “Ecass—2: Capacitor improvements and discussion,” in The 13^{th} International Seminar on Double Layer Capacitors and Hybrid Energy Storage Devices, Dec. 8, 2003, pp. 215-225) utilizes voltage and pressure to induce “fissures” in graphitic carbon. In the laboratory, these devices have achieved increased energy densities of 27 Wh/kg at a power density of 7 kW/kg, and increased voltage levels of 3.7 volts. However, these fissures appear to exhibit an unstable self-closing behavior, and commercial devices, although announced by Power Systems, are not yet available.

In 1997, Niu et al. (C. Niu, E. K. Sichel, R. Hoch, D. Moy, and H. Tennent, “High power electrochemical capacitors based on carbon nanotube electrodes,” Applied Physics Letters, vol. 70, no. 11, 99. 1480-1482, Mar. 17, 1997) were the first to show that carbon-nanotube-coated electrodes could potentially achieve better performance than activated carbon electrodes. By utilizing a 24 μm electrode made with entangled multi-wall carbon nanotubes (MWNTs), Niu's DLC electrode achieved a BET surface area of about 430 m²/g with an average pore size of 9.2 nm, and exhibited a power density of 8 kW/kg and an energy density of about 1 Wh/kg. The improved energy density results from the high surface area and more favorable matching of pore sizes to electrolyte ion dimensions. On the negative side, the pores are larger than optimum, the interface between the active layer and the current collector introduces a contact resistance and therefore limits the power density, and the cell utilizes an acqueous electrolyte with H₂SO₄ that limits the maximum voltage to about 1 volt.

In 2002, An et al. (K. H. An, W. S. Kim, Y. S Park, J.-M. Moon, D. J. Bae, S. C. Lim, Y. S. Lee, and Y. H. Lee, “Electrochemical properties of high-power supercapacitors using single-walled carbon nanotube electrodes,” Advanced Functional Materials, vol. 11, no. 5, pp. 387-392, October 2001) demonstrated a significant advancement from Niu's device by employing a paste of entangled single wall nanotubes (SWNTs) for the electrode active layer. An's electrode achieved an energy density of about 7 Wh/kg and a power density of about 20 kW/kg. Like Niu's cell, an aqueous electrolyte with KOH is used, limiting the maximum voltage to 0.9 volts. An's improvement stems from the smaller pore size provided by the single wall nanotubes, plus the use of a polyvinylidene chloride binder to reduce the effective series resistance. On the negative side, the binder introduces impurities that limit the ionic mobility between the pores of the active layer, and the aqueous electrolyte severely limits the maximum operating voltage.

In 2003, Emmenegger et al. (C. Emmenegger, P. Mauron, P. Sudan, P. Wenger, V. Hermann, R. Gallay, and A. Zuttel, “Investigation of electrochemical double-layer (EDLC) capacitors electrodes based on carbon nanotubes and activated carbon materials,” Journal of Power Sources, vol. 124, pp. 321-329, Apr. 14, 2003) were the first to present an electrode in which an active layer of entangled nanotubes is grown directly on a conducting substrate. This technique leads to a considerable reduction of the electrode equivalent series resistance that translates into a remarkable increase in the power density (260 kW/kg). Emmenegger's cell also utilizes an organic electrolyte that provides a cell rated voltage of 2.5 volts and an electrode energy density of 15 Wh/kg. The primary limitations of Emmenegger's electrode are its low surface area (100 m²/g) and the small thickness of the active layer (30 μm).

This ultracapacitor research suggests the possibility of improved energy storage, but the projected storage densities are still less than 10% of a battery's capability, and these capacitors have other drawbacks such as limited stability (nanogate), high series resistance and low operating voltage (An et al.), and thin electrode structures (Emmenegger et al.).

A research group from Tokyo University (Yoichi Murakami, Shohei Chiashi, Yuhei Miyauchi, Minghui Hu, Masaru Ogura, Tatsuya Okubo, Shigeo Maruyama, “Growth of vertically aligned single-walled carbon nanotube films on quartz substrates and their optical anisotropy,” Chemical Physics Letters 385 (2004) 298-303) grew for the first time an array of vertically aligned single wall nanotubes by chemical vapor deposition of ethanol on a glass substrate having a density 10¹³ tubes/cm². Murakami's tubes had an average length of approximately 1.5 μm. The tubes were grown on a non-conducting substrate and were not for an energy storage application.

An object of the present invention is a structure that represents a paradigm change for energy storage. The basic concept of the engineered structures disclosed herein differs from both capacitors and batteries. The structures have an energy density substantially equivalent to that of conventional batteries.

### SUMMARY OF THE INVENTION

In one aspect, the engineered structure for charge storage according to the invention includes an electrolyte disposed between two electrically conducting plates, each plate serving as a base for an aligned array of electrically conducting nanostructures extending from the surface of each plate into the electrolyte. The nanostructures have diameter and spacing comparable to the dimension of an ion of the electrolyte. As used herein, nanostructure refers to any elongate structure on the nanometer scale such as, but not limited to, nanotubes, nanowires and various patterns of etched protrusions or depressions. An electrically insulating separator is disposed between the two plates. In a preferred embodiment, the nanostructures are nanotubes and the spacing between the nanotubes is approximately twice the electrolyte ion diameter. In another preferred embodiment, the electrically conducting plates include a metallic layer such as aluminum, a buffer layer or under-layer such as alumina and a non-continuous catalytic layer such as iron from which the aligned array of electrically conducting nanostructures extend. Suitable electrically conducting nanostructures include single-wall carbon nanotubes as well as multi-wall nanotubes. In one embodiment, the aligned nanotubes have a spacing of approximately 3 nm and an average diameter of 1.5 nm. It is also preferred that the length of the nanotubes be in the range of 60-500 μm or longer. Preferred electrolytes include organic electrolytes such as propylene carbonate, ethylene carbonate, other carbonates, nitrites, sulfoxides, amides, pyrrolidones, esters and ethers.

A preferred separator has high porosity (90%) that enables high ion mobility between the two electrodes. A suitable separator is a polypropylene and/or polyethylene electrolytic membrane available from Celgard LLC of Charlotte, N.C. Celgard material exhibits high electric voltage standoff capability permitting a thinner and lighter film for the isolation of the two electrodes. In a preferred embodiment, separator thickness is optimized to achieve an ideal compromise between electrolyte volume and voltage standoff capability. A paper separator may also be used.

In another aspect, the invention is an engineered structure for charge storage having an electrode including a nanostructure film disposed thereon. The film includes voids substantially equivalent to the size of a selected electrolyte ion. In a preferred embodiment, the nanostructure is a carbon nanotube.

In yet another aspect, the invention is a process for making an aligned array of electrically conducting nanostructures including forming a substrate having a surface with a non-continuous thin film of catalytic material thereon. The process includes growing an aligned array of electrically conducting nanostructures extending from the catalytic material in a chamber whose temperature and pressure are selected to provide desired geometric characteristics for the nanostructure array. A suitable process is chemical vapor deposition, CVD.

When an electrical potential is applied between the two electrodes, the resulting electric field causes negative electrolyte ions to move toward the positive electrode and positive electrolyte ions to move toward the negative electrode. These ions coat the electrode surfaces. Each ion is paired with on opposing charge on the electrode surface, and the buildup of these charges results in an electrical current flow into the device terminals. The energy represented by this current (the integral of current times voltage) is stored in the electrical field between the electrolyte ions and the charge on the plates. In this regard, the device behaves like an ultracapacitor, wherein the large electrode surface area and the small effective distance between the opposing charges yield a very high capacitance. In addition, because the nanostructures in the aligned array have diameter and spacing comparable to the dimension of an ion of the electrolyte, the ions can completely populate the interstices between the nanostructures. This aspect of the process is much the same as the way nature stores energy when ions plate out in an electrochemical battery. The structure of the invention can therefore achieve an energy density (greater than 30 Wh/kg) that is equivalent to several types of batteries. The energy storage device of the invention also offers instantaneous power density up to three orders of magnitude higher (greater than 30 kW/kg) than either batteries or fuel cells, practically unlimited lifetime (greater than 300,000 cycles), exceedingly high immunity to shock and vibration, limited temperature dependence, and near unity charging and discharging efficiency.

The engineered structures of the invention provide up to a two orders of magnitude increase in electrode surface area while maintaining uniform pore sizes that are well matched to the diameter of the electrolyte ions. Calculations indicate that the resulting energy storage density will be substantially equivalent to that of a conventional storage battery. At the same time, low contact resistance and ballistic transport exhibited by the structure of the invention results in improved power density while its high purity results in increased operating voltage and enhanced energy density. The engineered structures of the invention use more environmentally-friendly materials than a traditional battery. The design of the structures disclosed herein lends itself to mass production and costs are expected to be low.

Several phenomena associated with the engineered nanostructures and devices of the invention enhance performance. Nanotube conduction exhibits a phenomenon known as ballistic transport or quantum conduction so that the effective resistivity of the nanotube is extremely low. This situation is in contrast to the structure and bonding of activated carbon that leads to relatively high resistivity in conventional double layer capacitors. The quantum behavior of the nanotube structures according to embodiments of the invention provide a high density of electronic states at the surface of the tube as compared to low density of electronic states of activated carbon structures in a traditional DLC that provides a limited number of electron sites thereby limiting capacity. The structures according to the invention exhibit regular and controlled spacing allowing electrolyte access to the entire surface area unlike the highly non-uniform pore size in prior art activated carbon DLCs. Further, carbon nanotubes, with no defects, are expected to sustain on the order of 4 V as compared with prior art DLCs in which the activated carbon contains impurities and defects that react with the electrolyte to limit the maximum breakdown voltage to about 2.6 V. The increased voltage results in a 2.5:1 increase in energy storage density.

### BRIEF DESCRIPTION OF THE DRAWING

The invention is described with reference to the several figures of the drawing, in which:

FIG. 1 is a cross-sectional view of an embodiment of the engineered structures according to the invention.

FIG. 2 is a cross-sectional view of an embodiment of a substrate used in the engineered structure disclosed herein.

FIG. 3 is a schematic plan view of the substrate shown in FIG. 2.

### DETAILED DESCRIPTION OF CERTAIN PREFERRED EMBODIMENTS

First of all, the theory on which the present invention is based will be discussed. Chemical batteries provide electrons to an external circuit by either (1) absorbing charged electrolyte ions into neutral molecules that plate onto the surface of the battery electrodes, or (2) absorbing charged electrolyte ions into a chemical lattice that comprises the battery electrode. In either case, the density of the electron storage is basically equal to the density of the plating molecules (as in a lead-acid battery), or to the density of the ions in the chemical lattice (as in a lithium ion battery).

The inventors herein recognized that current nanotechnology processes can be used to coat electrodes with an inert nanostructure, such as nanotubes, lattice or structure having voids comparable in size to the electrolyte ions. When a voltage is applied to the electrodes, these voids attract and absorb ions with the equivalent density to the ion spacing in the lead sulfate plating within a lead-acid battery or to the lithium atom spacing in the lattice of a lithium ion battery. However, while the nanotubes perform a similar function as in a battery, there is no chemical reaction between the ions and the nanotubes. Therefore, the reaction is completely reversible and can take place very rapidly. The engineered structures for charge storage according to the invention function more like a battery than a capacitor, except that the ions are held in place by electrostatic attraction rather than through a chemical reaction and the “stored energy via an electric field” is external (between the ions and the nanotubes) rather than internal (within a chemically-combined molecule). The energy density capacity of the structures of the invention is comparable to that of chemical batteries.

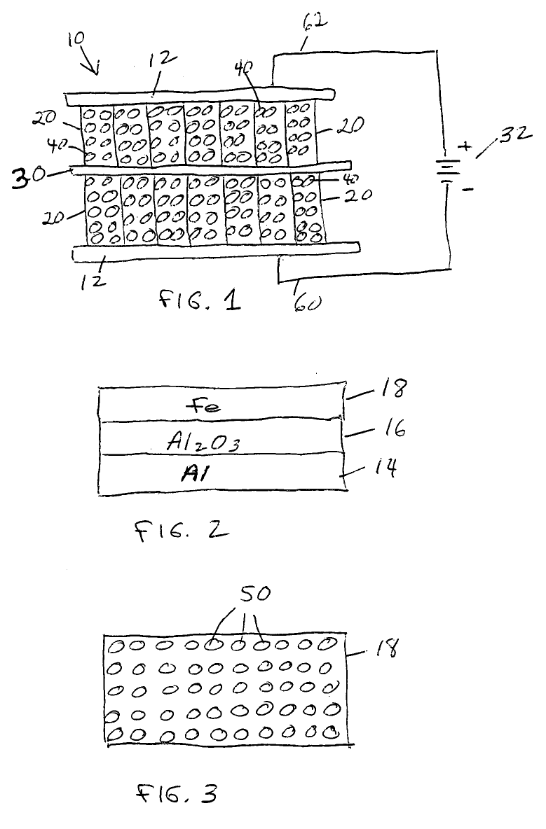

With reference now to FIG. 1 an engineered nanostructure 10 includes electrically conducting plates 12. The conducting plates 12 may be a metal such as aluminum coated with a multilayer structure as shown in FIG. 2. The multilayer structure includes an aluminum layer 14, an alumina layer 16 and an iron layer 18.

Carbon nanotubes, preferably single-wall carbon nanotubes (SWCNT) extend approximately perpendicularly from the plates 12 and extend to a separator 30 disposed between the plates 12. An electrolyte (not shown), preferably an organic electrolyte such as propylene carbonate or acetonitrile is disposed between the plates 12.

When a voltage is supplied, for example, by a battery 32 connected across the plates 12, ions 40 of the electrolyte migrate into the interstices between the nanotubes 20. By having the spacing between the nanotubes 20 be approximately two times the diameter of the ions 40, all of the surface area on the outside of the nanotubes 20 is available for receiving the ions 40 thereby storing electrical energy in a way similar to the way in which energy is stored in an electrochemical battery.

An important component in the system disclosed herein is the electrolyte because the interaction between the engineered electrode and electrolyte dictates the rated voltage and specific capacitance of the energy storage device of the invention. Organic electrolytes should be selected that offer a good balance between ionic mobility and decomposition voltage. Of course, aqueous inorganic electrolytes can be used, but a lower rated voltage will result. Suitable organic electrolytes include carbonates such as propylene carbonate (PC), ethylene carbonate, butylene carbonate, dimethyl carbonate, diethyl carbonate, dipropyl carbonate, methyl ethyl carbonate, methyl butyl carbonate, methyl propyl carbonate, ethyl propyl carbonate, butyl propyl carbonate, 1,2-butylene carbonate, 2,3- butylene carbonate, 1,2-pentene carbonate, 2,3-pentene carbonate; nitriles such as acetonitrile, acrylonitrile, propionitrile; sulfoxides such as dimethyl sulfoxide, diethyl sulfoxide, ethyl methyl sulfoxide, benzylmethyl sulfoxide; amides such as formamide, dimethyl formamide; pyrrolidones such as N-methylpyrrolidone; esters such as p-butyrolactone, y-butyrolactone, y-valerolactone, b-valerolactone, gamma-butyrolactone, 2-methyl-gamma-butyrolactone, acetyl-gamma-butyrolactone, gamma-valerolactone, phosphate trimesters; and ethers such as 1,2-dimethoxyethane, 1,2-ethoxyethane, diethoxyethane, methoxyethoxyethane, dibutoxyethane, nitromethane, dimethoxypropane, diethoxypropane, methoxyethoxypropane, tetrahydrofuran (THF), 2-methyl-tetrahydrofuran, alkyltetrahydrofurans, dialkyltetrahydrofurans, alkoxytetrahydrofurans, dialkoxytetrahydrofurans, 2-methyltetrahydrofuran, 1,2-dioxolane, 1,3-dioxolane, 1,4-dioxolane, 2-methyldioxolane, 4-methyl-dioxolane, alkyl-1,3-dioxolanes, sulfolane, 3-methylsulfolane, diethyl ether, diethylene glycol dialkyl ethers, triethylene glycol diethyl ether, ethylene glycol dialkyl ethers, diethylene glycol dialkyl ethers, triethylene glycol dialkyl ethers, tetraethylene glycol dialkyl ethers, alkyl propionates, dialkyl malonates, alkyl acetates, methyl formate, methyl acetate, methyl propionate, ethyl propionate, maleic anhydride.

Previous work by Okamura cited above achieved a cell rated voltage of 3.6 volts using graphite and polycarbonate electrolyte. This voltage is one of the highest ratings for a single double layer capacitor cell that has been recorded. Since the carbon nanotubes used in this embodiment of the invention are less reactive than activated carbon, and even graphite, it is expected that an even higher voltage rating, perhaps as high as 4 V, can be achieved. Since energy is proportional to the square of the voltage, the voltage increase accorded by the invention leads to a significant increase in energy storage density.

The separator 30 is an electrically insulating polymer that has high porosity that enables high ion mobility between the electrodes. A suitable separator is a thin paper film or a thin film available from Celgard LLP. Separator thickness is optimized to achieve an ideal compromise between capacitor volume, standoff capability, and stored electrolyte volume.

The method for making the engineered structures of the invention will now be described. An under-layer film with a thickness ranging from 0 to 1,000 Angstroms is deposited on a metallic substrate such as aluminum using E-beam deposition techniques. Metal oxides and metal nitrides are suitable for the under-layer film 16 shown in FIG. 2. A preferred under-layer film is Al₂O₃. A catalyst film having a thickness ranging from 3 to 50 Angstroms is deposited by E-beam deposition onto the under-layer film 16. A preferred catalyst is iron. Generally, a suitable catalyst is a transition metal selected from scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, gold, mercury, rutherfordium, dubnium, seaborgium, bohrium, hassium, meitnerium. The role of the interface between the catalyst layer 18 and the under-layer film 16 is to favor the formation of catalyst nanoparticles (iron, for example) that provide nucleation sites during nanotube growth discussed below.

After depositing the under-layer 16 and the catalyst film 18 by electron beam deposition, the multilayer structure shown in FIG. 2 is introduced into a low pressure (LP) chemical vapor deposition chamber (CVD). Pressure in the CVD chamber is decreased to background pressure lower than 20 mTorr to reduce significantly the presence of contaminants and impurities in the chamber.

The next step is a pre-growth treatment process to form the catalyst nanoparticles 50 shown in FIG. 3. In this embodiment, the catalyst nanoparticles 50 are iron. Once the background pressure lower than 20 mTorr is achieved, the multilayer structure is heated to a temperature ranging from 500° C. to 850° C. and a pre-growth mixture of gases is flowed in the CVD chamber containing the multilayer structure on which nanotubes will be grown. A suitable pre-growth gas mixture includes an inert gas carrier (argon or helium) and hydrogen. The partial pressure of hydrogen over the total pre-growth gas mixture pressure ranges from 5 to 50 percent. The pre-growth gas mixture flows for a time ranging from 0 to 600 seconds. This pre-growth treatment ensures the formation of catalytic nanoparticles that give rise to the nanotube nucleation and growth subsequently. During the pre-growth treatment phase, catalyst nanoparticles self arrange in a desired size (between 1 and 20 nm) and spacing over the under-layer 16 (from 3 to 100 nm nanoparticle center to nanoparticle center). Those of ordinary skill in the art will appreciate that temperatures, gas mixtures and pressures and times are selected in this pre-growth treatment phase to achieve nanoparticles having a desired size and spacing.

The next step of the process is nanotube growth. After the pre-growth treatment discussed above is completed, a carbon-containing feedstock is introduced into the CVD chamber to begin carbon nanotube nucleation and subsequent growth. Suitable carbon feedstocks include benzene, ethylene, xylene, methane, acetylene, propylene, acetone, methanol, ethanol, diethyl ether, propanol and carbon monoxide. The partial pressure of the selected carbon feedstock in the CVD chamber during the growth phase varies from 1 to 40 percent over the total CVD chamber pressure. During the growth phase, the partial pressure of hydrogen over the partial pressure of hydrogen and argon can vary from 1 to 50 percent. The nanotube nucleation and growth takes place when the surface of the catalyst 18 on the multilayer structure is at a temperature between 500° C. and 850° C. It is preferred that the CVD chamber be maintained at an absolute pressure ranging from 200 mTorr to 1 atmosphere during nucleation and growth of nanotubes.

The carbon nanotube growth treatment yields vertically aligned single wall or multi-wall carbon nanotubes directly on top of the multi-layer structure that includes the conductive substrate, the under-layer, and the catalyst. The morphology of the nanotube ensemble obtained depends on the substrate, under-layer, and catalyst morphology as well as on the pre-growth and growth treatment conditions.

Carbon nanotube growth can last for a period of time between 10 seconds up to more than 10 hours. The duration of the nanotube growth depends on the desired length of the vertical nanotubes, on the desired type of nanotubes, on CVD pressure during the growth, on growth sample temperature during growth, on the ratio between the growth gases, and on the carbon feedstock used.

When the nanotubes have reached their desired length, nanotube growth is terminated by decreasing the sample temperature to below 200° C. and the CVD chamber pressure is reduced to an absolute value lower than 20 mTorr. Once the low background pressure of 20 mTorr is reached, the CVD chamber is filled with argon or helium to reach a chamber pressure of 1 atmosphere. Subsequently, the sample including the as-grown, vertical single wall or multi-wall nanotubes is removed from the CVD chamber.

After the electrodes 12 with the aligned, ordered nanotube array thereon are formed, the separator 30 is inserted between the electrodes along with the selected electrolyte. Suitable packaging will then encapsulate the entire structure as will be appreciated by those of ordinary skill in the art. Electrical leads 60 and 62 are then affixed to the conducting plates 12 thereby completing an engineered structure assembly according to this embodiment of the invention.

Because the engineered structure of the invention utilizes a forest of substantially vertically aligned carbon nanotubes with a spacing of, for example, 3 nm and having an average diameter of 1.5 nm, calculations indicate that the structure disclosed herein will have a surface area almost an order of magnitude greater than an entangled structure (1300 m²/g vs. 350 m²/g). Consequently, the expected energy density of an engineered structure utilizing the aligned single-wall nanotubes can exceed 30 Wh/kg, which is almost an order of magnitude higher than the best prior art ultracapacitor. This energy density is comparable to lithium ion batteries. Even if the energy density of the engineered structure disclosed herein falls somewhat short of an optimum, the resulting performance is still a highly desirable alternative to battery technology in many applications.

By growing the nanotubes directly on the current collector, the engineered structure disclosed herein will achieve a significant reduction of the electrode series resistance (compared to Emmenegger's electrode), leading to an expected peak power in excess of 30 kW/kg. The use of an organic electrolyte in conjunction with the binder-free nanotube electrode is expected to provide a rated voltage greater than 3 V and perhaps closer to 4 V. This rated voltage results from the high decomposition voltage of the organic electrolyte and from the chemically inert nature of pure carbon nanotubes. By controlling the nanotube spacing, (optimized, for example, at 3 nm), the existence of micropores that are too small to be penetrated by electrolyte ions is eliminated. In addition, the regular surface of the nanotube array avoids isolated electrolyte islands and avoids the multiple time constants of the prior art activated carbon device. The low contact resistance and the ballistic transport exhibited by the nanotube electrode structure disclosed herein results in a further improved power density, while its high purity results in increased operating voltage and further improved energy density.

It is recognized that modifications and variations of the invention disclosed herein will be apparent to those of skill in the art and it is intended that all such modifications and variations be included within the scope of the appended claims.

What is claimed is:

1) Engineered structure for charge storage comprising:
an electrolyte disposed between two electrically conducting plates, each plate serving as a base for an aligned array of electrically conducting nanostructures extending from the surface of each plate into the electrolyte, the nanostructures having diameters and spacing comparable to the dimension of an ion of the electrolyte; and an electrically insulating separator between the two plates.

2) The engineered structure of claim 1 wherein the nanostructures are nanotubes.

3) The engineered structure of claim 2 wherein the nanotubes are single-wall nanotubes.

4) The engineered structure of claim 3 wherein the single wall nanotubes have a length in the range of 60 to 500 μm.

5) The engineered structure of claim 1 wherein the electrolyte is selected from the group consisting of carbonates, nitrites, sulfoxides, amides, pyrrolidones, esters and ethers.

6) The engineered structure of claim 1 wherein the electrolyte is propylene carbonate.

7) The engineered structure of claim 1 wherein the electrolyte is an organic electrolyte.

8) The engineered structure of claim 1 wherein each plate is a multilayer structure.

9) The engineered structure of claim 8 wherein the multilayer structure includes a non-continuous thin film of catalytic material.

10) The engineered structure of claim 9 wherein the catalytic material is iron.

11) The engineered structure of claim 8 wherein the multilayer structure includes layers of silicon, alumina and iron.

12) The engineered structure of claim 1 wherein the spacing between nanostructures is approximately twice the diameter of an electrolyte ion.

13) The engineered structure of claim 1 wherein the spacing between the nanostructures is approximately the diameter of an electrolyte ion.

14) The engineered structure of claim 1 wherein the separator has a porosity between 40 and 90 percent.

15) The engineered structure of claim 14 wherein the separator is a paper based separator or Celgard.

16) The process for making an aligned array of electrically conducting nanostructures comprising:
forming a substrate having a surface including a non-continuous thin film of catalytic material; and
growing an aligned array of electrically conducting nanostructures extending from the catalytic material in a chamber whose temperature and pressure are selected to provide desired geometric characteristics for the nanostructure array.

17) The process of claim 16 wherein the growing step utilizes chemical vapor deposition.

18) The process of claim 16 wherein the non-continuous thin film of catalytic material is made by a pre-growth treatment in a CVD chamber.

19) The process of claim 16 wherein chamber temperature is in the range of 500° C. to 850° C.

20) The process of claim 16 wherein chamber pressure is in the range of 200 m Torr to 1 atmosphere.

21) Engineered structure for charge storage comprising:
an electrode including a nanostructure based film disposed thereon, the film including voids substantially equivalent to the size of a selected electrolyte ion.

22) The engineered structure of claim 21 wherein the nanostructure film is a nanotube array.

23) The process of claim 18 wherein the pre-growth treatment includes introduction of an inert gas carrier and hydrogen.

24) The process of claim 19 wherein the inert gas is argon or helium.
